(19) United States
(12) Patent Application Publication
(10) Pub. No.: US 2018/0076512 A1
(43) Pub. Date: Mar. 15, 2018

(54) AUTOMOBILE ALERTING DEVICE

(71) Applicant: Ching-Yi CHEN, Taipei City (TW)

(72) Inventor: Ching-Yi CHEN, Taipei City (TW)

(21) Appl. No.: 15/411,561

(22) Filed: Jan. 20, 2017

(30) Foreign Application Priority Data
Sep. 9, 2016 (TW) 105214052

(51) Int. Cl. H01Q 1/32; B60R 25/104; B60R 25/10; G08B 5/36; G08B 13/22; F21S 8/10; H05B 37/02

(52) U.S. Cl. CPC H01Q 1/3233; B60R 25/104; B60R 25/1001; H01Q 1/3266; F21S 48/234; G08B 5/36; G08B 13/22; F21S 48/328; H05B 37/0272; H01Q 1/3275

(57) ABSTRACT

An automobile alerting device includes an antenna housing, an antenna unit, a high-power light emitting unit, a roof joining portion and at least one light pervious portion. Not only light produced by the high-power light emitting unit may be emitted to the antenna housing through the light pervious portion, but also the alert light is raised to the top part of the automobile to eliminate severe safety issue that an alert light cannot be easily detected by a large vehicle as the height of a small-sized vehicle is lower than that of the large-sized vehicle. Further, the high-power light emitting unit at the roof and the vehicle lights at the two sides of the automobile jointly form an alert effect of triangular light emitting spots to further enhance the safety alert effect.

### BACKGROUND OF THE INVENTION

a) Field of the Invention

The invention relates in general to an automobile alerting device, and more particular to an automobile alerting device formed by an antenna housing, an antenna unit and a high-power light emitting unit. The automobile alerting device is mounted on the top part of an automobile and together form an alert effect by a triangular light emission with original automobile lamps at the two sides of the automobile, thereby enhancing the safety alert effect.

b) Description of the Prior Art

A conventional alert light is usually formed by automobile lights at two sides of front and rear of an automobile. In addition to allowing other vehicles ahead and behind to learn driving directions of the automobile, driving conditions of the automobile may also be reflected according to the light intensity or flashing the lights to produce a safety alert effect for other vehicles. It is known that, large-sized vehicles such trucks, hauler trucks and tour buses with large vehicle bodies have far greater lengths and heights than small-sized vehicles such as sedans and SUVs (Sport Utility Vehicle), which means that the height of a driver seat of a large-sized vehicle is inevitably greater than the height of that of a small-sized vehicle. Thus, when a small-sized vehicle progresses in front of or at two sides of a large-sized vehicle from an appropriate distance, by looking down the small-sized vehicle, the driver of the large-sized vehicle may easily perceive alert lights from the two sides of the front and rear sides of the small-sized vehicle. At this point, the lights of the small-sized vehicle do achieve a safety alert function, so that the large-sized vehicle may appropriately adjust driving conditions to ensure driving safety. However, as shown in FIG. 1, when a small-sized vehicle 80 is behind a large-sized vehicle 9, as the vehicle body behind the driver seat of the large-sized vehicle has larger length and width, even when no passengers or freight is carried, the vehicle body at the rear part of the large-sized vehicle 9 can still easily block the view of the driver. Further, top and bottom widths of the rear mirror 91 near the driver seat in the large-sized vehicle 9 are limited, in a way that blind spots are formed on an image reflected by the rear mirror 91 for conditions behind. Meanwhile, as the size of the rear window behind the driver seat of the large-sized vehicle 9 similarly limits visual ranges of the rear mirror 91 and the driver, it is difficult for the driver of the large-sized vehicle 9 to perceive the small-sized vehicle 80 and vehicle lights 82 behind, hence causing a severe safety issue. Therefore, there is a need for a solution for improving the above issue.

Audiovisual equipments such as sound systems and monitors currently installed in an automobile can generally receive radio signals through an externally connected vehicle antenna, so as to play music, broadcasting or video programs in the automobile. Further, satellite navigation equipments may also use this vehicle antenna to transmit satellite positioning signals. The vehicle antenna is usually disposed at the top part of the automobile, including parts at the roof or near the vehicle body or windows. In addition to a straight-type antenna, vehicle antenna having a streamline appearance are also commercially available. In a vehicle antenna having a streamline appearance, an antenna unit wound from an antenna is installed in an antenna housing made of a plastic material, and the antenna housing can usually be designed with various types of streamline appearances. As opposed to a straight-type antenna, the streamline appearance of such antenna housing with better esthetic values is further capable of preventing an external factor such as bad weather from affecting functions. An outer wall of the roof of an automobile is usually provided with a through hole leading to the interior of the automobile, so as to allow a wire for transmitting radio signals to be penetrated to an interior of the automobile through the through hole at the roof to further electrically connect to audiovisual equipments in the automobile. The foregoing antenna housing having a streamline appearance is capable of covering the through hole at the roof to prevent external rain water from seeping into the automobile.

It is known from the above description that, technologies for commercial vehicle antennas with specially designed appearances need to be improved. For example, how a current vehicle antenna with a specially designed appearance provides no substantial help in the safety issues that a driver of a large-sized vehicle cannot easily perceive a small-sized vehicle behind and alert lights of the small-sized vehicle. Therefore, based on many years of research and practical experience in the related field, the Applicant provides an automobile alerting device for improving the above drawbacks of the prior art.

### SUMMARY OF THE INVENTION

In view of the above, it is a primary object of the present invention to provide an automobile alerting device mounted to a top part of an automobile to raise an alert light to the top part of the automobile, thereby together forming an alert effect of triangular light emitting points with existing vehicle lights at the two sides of the automobile.

To achieve the above object, the automobile alerting device of the present invention includes an antenna housing, an antenna unit disposed in the antenna housing and a high-power light emitting unit. The antenna housing is formed by a roof joining portion and at least one light pervious portion, and is mounted at the top part of an automobile, such that light emitted produced by the high-power light emitting unit is emitted to an exterior of the antenna housing through the light pervious portion. Thus, the alert light of the high-power light emitting unit is raised to the top part of the automobile to improve the issue that a driver of a large-sized vehicle cannot easily perceive a small-sized vehicle behind and alert lights of the small-sized vehicle. Further, together with the existing vehicle lights at the two sides of the front and rear of the automobile, the high-power light emitting unit and the vehicle lights at the two sides of the automobile jointly form an alert effect of triangular light emitting points, thereby enhancing the safety alert effect.

According to the above main structural characteristics, the antenna housing includes an outer cover and a seat. The outer cover is disposed at an upper side of the seat, and a cavity is formed between the outer cover and a top part of the seat. The antenna unit and the high-power light emitting unit are disposed in the cavity. The light pervious portion is disposed on the outer cover. The roof joining portion is disposed at a bottom part of the seat.

According to the above main structural characteristics, the outer cover includes at least one ridge and at least one inclined surface slantingly extended from the ridge towards the seat. One of the ridge and the inclined surface may form the light pervious portion. The outer cover may be designed to appear as a shark fin.

According to the above main structural characteristics, one of an inner surface and an outer surface of the light pervious portion is provided with a concave-convex reflecting surface structure.

According to the above main structural characteristics, the antenna unit may be implemented by one of an AM antenna unit, an FM antenna unit, a satellite antenna unit and a GPS antenna unit.

According to the above main structural characteristics, the high-power light emitting unit may be implemented by one of a light emitting diode (LED), an LED in a chip-on-board (COB) package, an incandescent light and a fluorescent light.

According to the above main structural characteristics, the antenna housing is provided with a ventilation structure for dissipating heat of the high-power light emitting unit. The ventilation structure includes a ventilation opening in communication with the interior and exterior of the antenna housing.

According to the above main structural characteristics, the top part of the automobile is provided with a through hole that allows a wire of the antenna unit to penetrate to an interior of the automobile, and a wire disposed at the high-power light emitting unit is penetrated to the interior of the automobile via the through hole.

According to the above main structural characteristics, the wire of the high-power light emitting unit is electrically connected to the vehicle lights at the two sides of the automobile.

According to the above main structural characteristics, the wire disposed at the high-power light emitting unit is electrically connected to an electronic control unit (ECU) of the automobile, such that the high-power light emitting unit is controlled by the ECU and is controlled by a remote controller of the automobile through the ECU.

According to the above main structural characteristics, the wire disposed at the high-power light emitting unit and the ECU are electrically connected to a delay circuit, such that the delay circuit is controlled by the ECU to delay the light emitted by the high-power light emitting unit.

According to the above main structural characteristics, the wire of the high-power light emitting unit is electrically connected to an antitheft device of the automobile.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a conventional automobile alert light in application;

FIG. 2 is an overall appearance diagram according to a preferred embodiment of the present invention;

FIG. 3 is an exploded view of FIG. 2;

FIG. 4 is a further exploded view of FIG. 3;

FIG. 5 is a schematic diagram of the embodiment in FIG. 2 in application;

FIG. 6 is a partial enlarged section view of FIG. 5 in application;

FIG. 7 is a partial enlarged section view of a light pervious portion of an antenna housing in FIG. 2; and

FIG. 8 is a function flowchart of FIG. 5 in application.

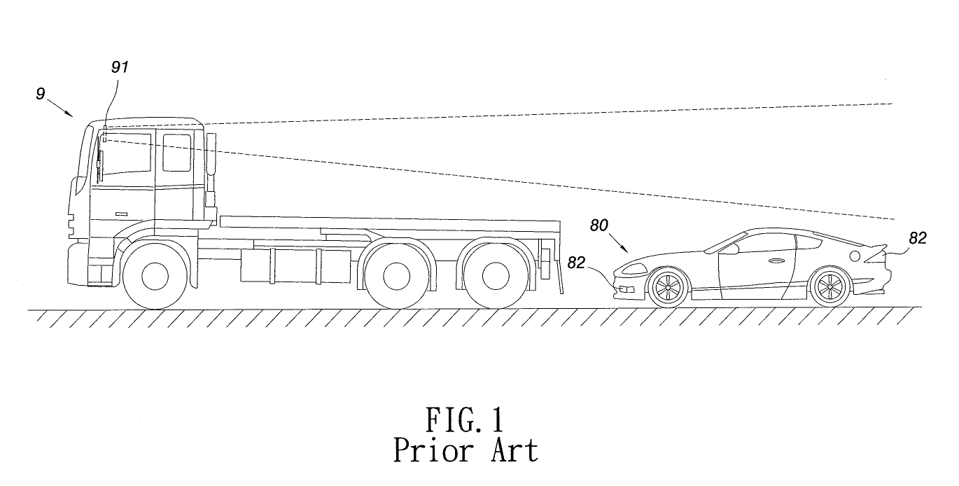

### DETAILED DESCRIPTION OF THE PREFERRED EMBODIMENTS

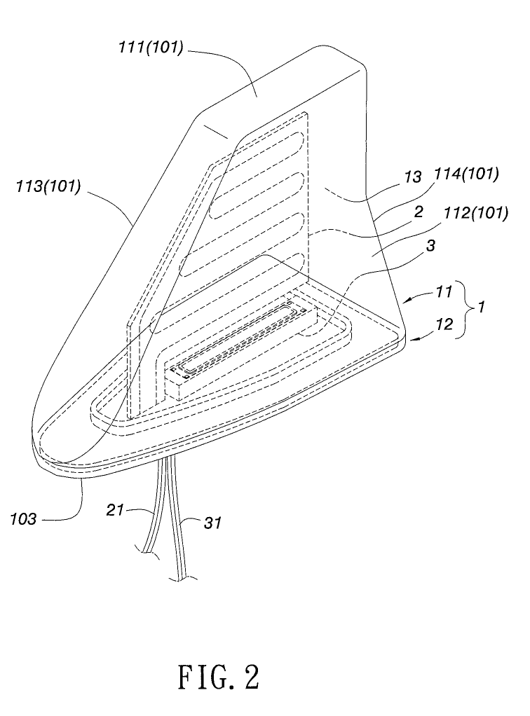

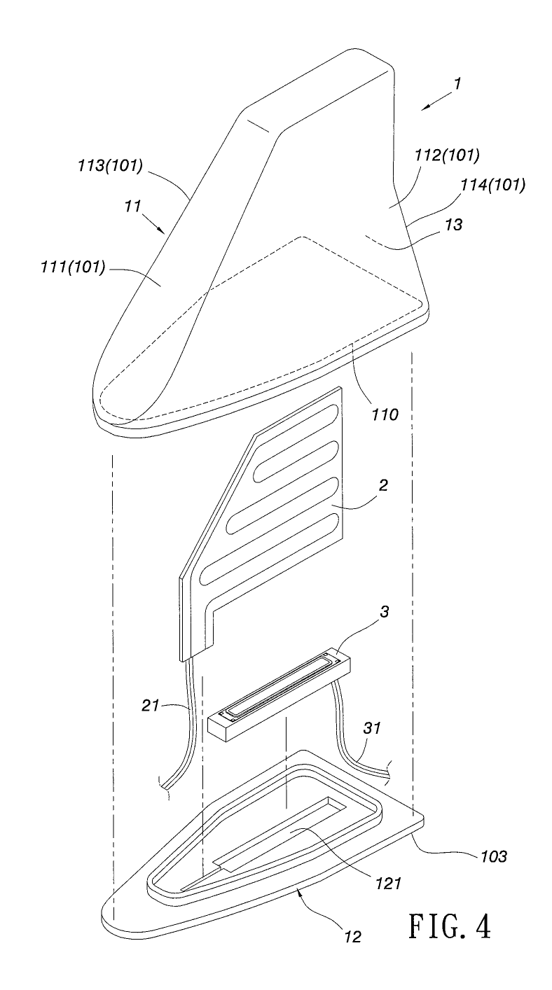

Referring to FIG. 2 to FIG. 4 showing an automobile alerting device according to an embodiment of the present invention, the automobile alerting device is mainly a structure including an antenna housing 1, an antenna unit 2 disposed in the antenna housing 1, and a high-power light emitting unit 3. The antenna housing 1 is provided with at least one light pervious portion 101, and a roof joining portion 103 disposed opposite the light pervious portion 101. The antenna housing 1 includes an outer cover 11 with a streamline appearance, and a seat 12. The outer cover 11 includes an opening 110 (as shown in FIG. 4) at a bottom part, and is disposed in a covering manner at an upper side of the seat 12 through the opening 110 at the bottom part. A cavity 13 is formed between an interior of the outer cover 11 and the upper side of the seat 12, so as to allow the antenna unit 2 and the high-power light emitting unit 3 to be placed in the space formed by the cavity 13 and be fixed at the upper side of the seat 12. The light pervious portion 101 is disposed at the outer cover 11. A lower side of the seat 12 forms the roof joining portion 103. More specifically, the outer cover 11 includes at least one ridge 111, at least one inclined surface 112, 113 and 114 slantingly extended from the ridge 111 towards the seat 12. The ridge 111 and/or the inclined surfaces 112, 113 and 114 form the light pervious portion 101. In the embodiment, the outer cover 11 is disposed to appear as a shark fin. In other embodiments, the outer cover 11 may be designed as other shapes.

The antenna unit 2 is may be implemented by an AM antenna unit 2, an FM antenna unit 2, a satellite antenna unit 2 and/or a GPS antenna unit 2. The high-power light emitting unit 3 may be implemented by an light emitting diode (LED), an LED in a chip-on-board (COB) package (formed by directly packaging one or multiple LED dies on a printed circuit board (PCB)), an incandescent light and/or a fluorescent light. Further, the antenna unit 2 may be a strip, a circle or a polygon in shape. The high-power light emitting unit 3 emits light, and causes the light to emit through the light pervious portion 101 formed by the ridge 111 and the inclined surfaces 112, 113 and 114 of the outer cover 11 to the exterior of the antenna housing 1.

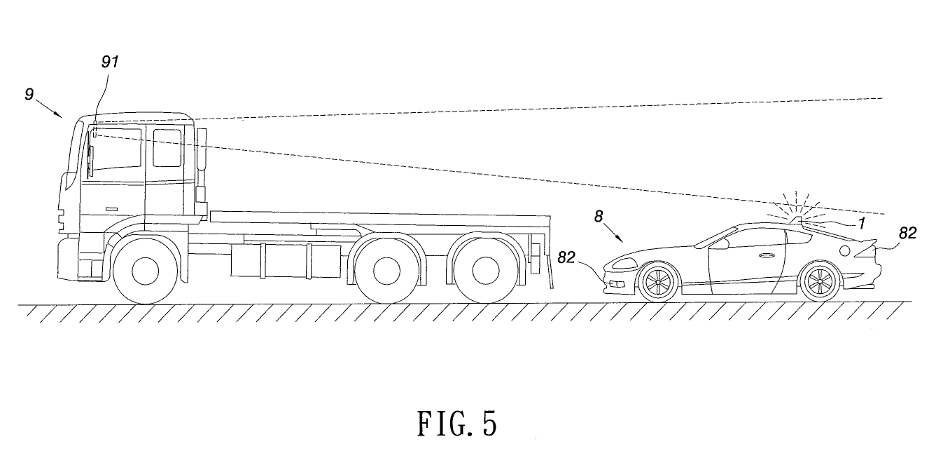

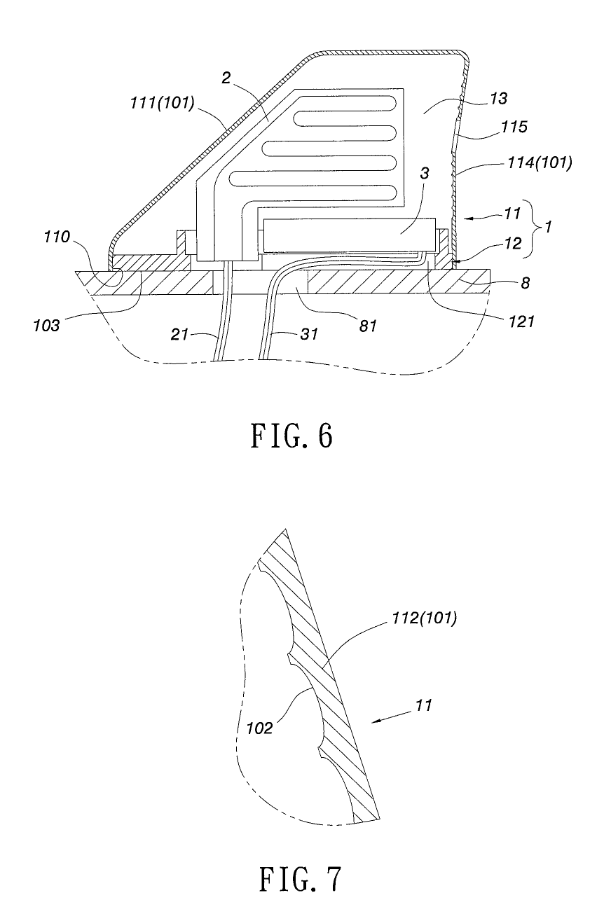

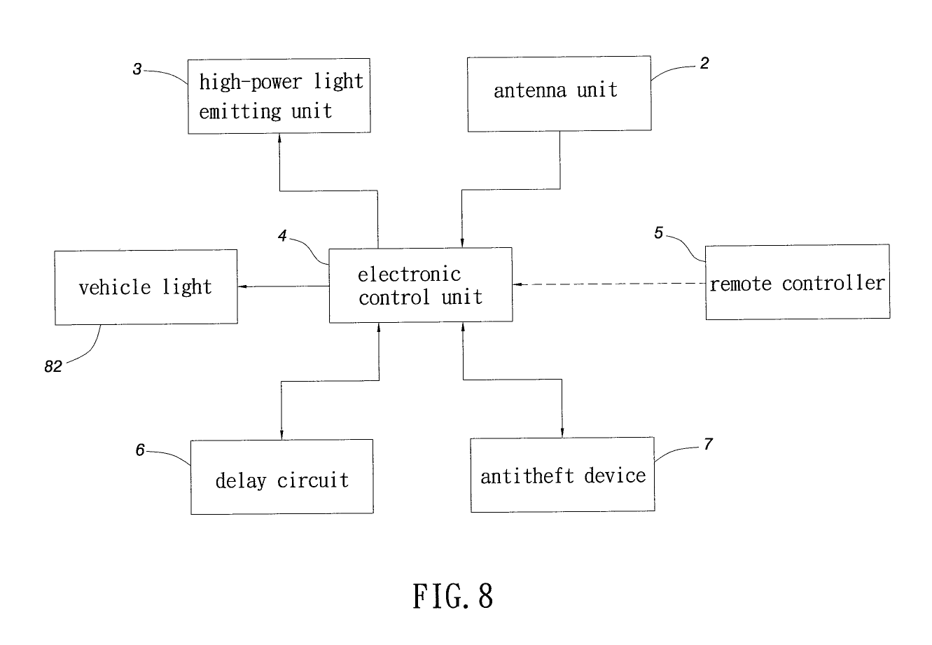

Referring to FIG. 5 and FIG. 6, in a preferred embodiment of the present invention, the antenna housing 1 may be mounted to a top part of a small-sized automobile 8 (e.g., a position at the roof or vehicle body or window near the roof) through the roof joining portion 103 at the bottom part of the antenna housing 1. The top part of the automobile 8 is provided with a through hole 81 (as shown in FIG. 6), and the seat 12 of the antenna housing 1 includes a perforation hole 121 in communication with the through hole 81 of the automobile 8 (as shown in FIG. 4 and FIG. 6). The perforation hole 121 and the through hole 81 allow a wire 21 of the antenna unit 2 to be penetrated to the interior of the automobile 8. A wire 31 of the high-power light emitting unit 3 may also be penetrated to the interior of the automobile 8 via the perforation hole 121 and the through hole 81, such that the wires 21 and 31 of the antenna unit 2 and the high-power light emitting unit 3 share the same through hole 81 at the roof. As such, the two wires 21 and 31 may be guided into the vehicle without damaging the vehicle body for providing an additional through hole, hence providing features of keeping the intactness of the vehicle structure, preventing rain water from seeping through, and having simple installation and structure. Referring to FIG. 8, the wires 21 and 31 of the antenna unit 2 and the high-power light emitting unit 3 may be electrically connected to an electronic control unit (ECU) 4 of the automobile 8, so as to cause the wire 31 of the high-power light emitting unit 3 to be electrically connected to vehicle lights 82 at two sides of the front and rear of the automobile 8. Thus, the high-power light emitting unit 3 and the vehicle lights 82 are together controlled by the ECU 4 and may be operated by the driver of the automobile 8.

As shown in FIG. 2 and FIG. 5, when applying the present invention, light produced by the high-power light emitting unit 3 emits to an exterior of the antenna housing 1 through the light pervious portion 101 of the outer cover 11. Thus, the alert light of the high-power light emitting unit 3 is raised to the top part of the automobile 8 to form an effect of projecting light towards above the top part of the automobile 8. As the antenna housing 1 itself is capable of wireless communication using the antenna unit 2 therein, an even better safety alert effect is generated through the high-power light emitting unit 3 as opposed to the vehicle lights at the two sides of a vehicle of the prior art. It should be noted that, due to drastic differences between heights and lengths of the automobile 8 and a large-sized vehicle 9, when the automobile 8 progresses near the rear of the large-sized vehicle 9, blind spots of visual reflection from a driver seat are formed as a result of a limited width of a rear mirror 91 of the large-sized vehicle 9, and an image reflected is incapable of reflecting the entire vehicle body of the automobile 8 currently approaching from behind. In the event of a sudden emergency, the automobile 8 may alert the large-sized vehicle 9 ahead using flashing yellow lights at the two sides of its vehicle body. However, the image reflected by the rear mirror 91 of the large-sized vehicle 9 may fail to include positions of the vehicle lights 82 at the two sides of the automobile 8 because the height of the automobile 8 is far lower than the height of the large-sized vehicle 9. In the present invention, as previously described, because the alert light of the high-power light emitting unit 3 is raised to the top part of the automobile 8 to form an effect of projecting light towards above the top part of the automobile 8, the rear mirror 91 of the large-sized vehicle 9 is capable of clearly reflecting the alert light emitted from the high-power light emitting unit 3 of the rear vehicle. Thus, the driver of the large-sized vehicle 9 is allowed to easily learn conditions of other rear vehicles, thereby improving the severe safety issue that a driver of a large-sized vehicle cannot easily perceive rear vehicles and their alert lights. Further, with the existing vehicle lights 82 at the two sides of the front and rear of the automobile 8 and the control of the ECU 4 of the automobile 8, the high-power light emitting unit 3 at the roof and the vehicle lights 82 at the two sides of the automobile 8 together form an alert effect of triangular light emitting points, thereby further enhancing the safety alert effect, which particularly provides an excellent light alerting function in the rain or fog.

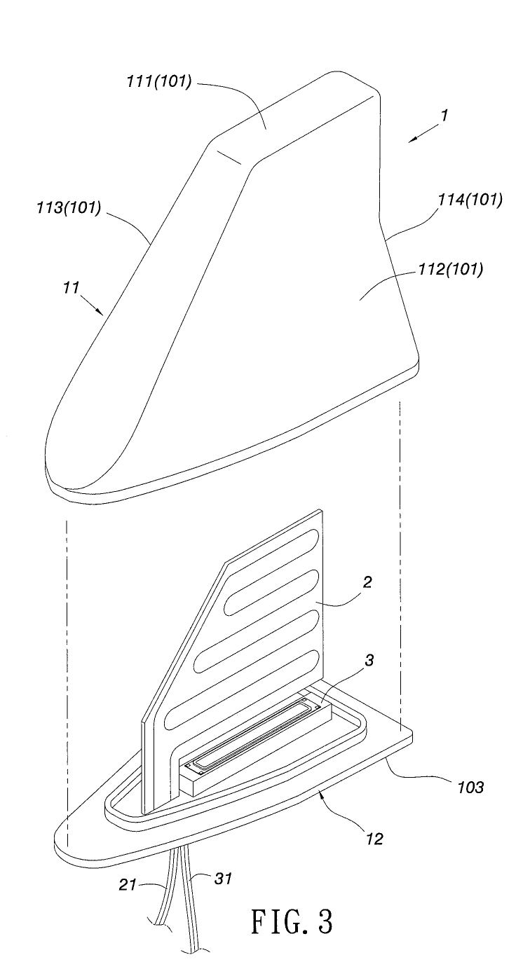

Referring to FIG. 7 as well as FIG. 3, in one possible embodiment, an inner surface and/or an outer surface of a light pervious portion 101 formed by the ridge 111 and the inclined surfaces 112, 113 and 114 of the outer cover 11 may be provided with a concave-convex reflecting surface structure 102. The concave-convex reflecting surface structure 102 may be a semi-circular and arched concave-convex structure, so as to produce an effect of focusing or changing a light pattern of the light emitted from the high-power light emitting unit 3. Thus, the light intensity of the high-power light emitting unit 3 may be increased, while power needed for driving the high-power light emitting unit 3 to emit can be reduced.

As shown in FIG. 6, in another embodiment, the antenna housing 1 is provided with a ventilation structure 115. For example, the ventilation structure 115 may be implemented as a ventilation opening in communication with the interior and exterior of the antenna housing 1, and is for dissipating heat of the high-power light emitting unit 3, so as to ensure the light emitting performance of the high-power light emitting unit 3 as well as increasing the lifecycle of the high-power light emitting unit 3.

Referring to FIG. 8 as well as FIG. 5, in one embodiment, the high-power light emitting unit 3 may be controlled by a remote controller 5 of the automobile 8 through the ECU 4. As such, when an automobile owner wishes to find the automobile 8 parked at a parking lot, the ECU 4 of the automobile 8 may be remote controlled using the remote controller 5 to cause the vehicle lights 82 at the two sides of the front and rear of the automobile 8 to emit light and generate a prompting light at the top part of the automobile 8, hence facilitating the automobile owner to find the automobile 8. Further, the wire 31 of the high-power light emitting unit 3 and the ECU 4 may further be electrically connected to a delay circuit 6. The delay circuit 6 is controlled by the ECU 4 to delay or stop the light emission from the high-power light emitting unit 3. Thus, when the vehicle lights 82 at the two sides of the automobile 8 and the high-power light emitting unit 3 at the roof of the automobile 8 emit light simultaneously, through the control of the delay circuit 6, a period in which the high-power light emitting unit 3 emits light may be longer than a period in which the vehicle lights 82 at the two sides of the automobile 8 emit light to further facilitate the automobile owner to find the automobile 8. As such, an issue of having difficulties in finding the automobile 8 when the vehicle lights 82 at the two sides of the automobile 8 are blocked by other vehicles parked at the right and left sides of the automobile 8 can be eliminated.

Further, in another embodiment, the wire 31 of the high-power light emitting unit 3 may be electrically connected to an antitheft device 7 of the automobile 8. Thus, when the antitheft device 7 is triggered, the vehicle lights 82 at the two sides of the automobile 8 are driven to emit light while the high-power light emitting unit 3 at the roof of the automobile 8 is also driven to emit light, hence producing an effect of vehicle theft warning.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automobile alerting device, comprising an antenna housing, an antenna unit disposed in the antenna housing, and a high-power light emitting unit, the antenna housing is provided with a roof joining portion and at least one light pervious portion to allow light produced by the high-power light emitting unit to emit to an exterior of the antenna housing through the light pervious portion.

2. The automobile alerting device according to claim 1, wherein the antenna housing comprises an outer cover and a seat, the outer cover is disposed at an upper side of the seat, a cavity is formed between the outer cover and the upper side of the seat, the antenna unit and the high-power light emitting unit are disposed in the cavity, the light pervious portion is disposed on the outer cover, and the roof joining portion is disposed at a bottom part of the seat.

3. The automobile alerting device according to claim 2, wherein the outer cover is provided with at least one ridge and at least one inclined surface slantingly extended from the ridge towards the seat, and one of the ridge and the inclined surface forms the light pervious portion.

4. The automobile alerting device according to claim 1, wherein one of an inner surface and an outer surface of the light pervious portion is provided with a reflecting surface structure.

5. The automobile alerting device according to claim 2, wherein one of an inner surface and an outer surface of the light pervious portion is provided with a reflecting surface structure.

6. The automobile alerting device according to claim 3, wherein one of an inner surface and an outer surface of the light pervious portion is provided with a reflecting surface structure.

7. The automobile alerting device according to claim 1, wherein the antenna unit is implemented by one of an AM (Amplitude Modulation) antenna unit, an FM (Frequency Modulation) antenna unit, a satellite antenna unit and a GPS (Global Positioning System) antenna unit.

8. The automobile alerting device according to claim 1, wherein the high-power light emitting unit is implemented by one of a light emitting diode (LED), an LED in a chip-on-board (COB) package, an incandescent light and a fluorescent light.

9. The automobile alerting device according to claim 1, wherein the antenna housing is provided with a ventilation structure for dissipating heat of the high-power light emitting unit.

10. The automobile alerting device according to claim 8, wherein the antenna housing is provided with a ventilation structure for dissipating heat of the high-power light emitting unit.

11. The automobile alerting device according to claim 1, wherein the antenna housing is mounted to a top part of an automobile through the roof joining portion, the top part of the automobile is provided with a through hole for a wire of the antenna unit to penetrate to an interior of the automobile, and a wire of the high-power light emitting unit is penetrated to the interior of the automobile via the through hole.

12. The automobile alerting device according to claim 11, wherein the wire of the high-power light emitting unit is electrically connected to a vehicle light of the automobile.

13. The automobile alerting device according to claim 11, wherein the wire of the high-power light emitting unit is electrically connected to an electronic control unit (ECU) of the automobile, to cause the high-power light emitting unit to be controlled by the ECU and be controlled by a remote controller of the automobile through the ECU.

14. The automobile alerting device according to claim 12, wherein the wire of the high-power light emitting unit is electrically connected to an electronic control unit (ECU) of the automobile, to cause the high-power light emitting unit to be controlled by the ECU and be controlled by a remote controller of the automobile through the ECU.

15. The automobile alerting device according to claim 13, wherein the wire of the high-power light emitting unit and the ECU are electrically connected to a delay circuit, which is controlled by the ECU to delay or stop light emission of the high-power light emitting unit.

16. The automobile alerting device according to claim 14, wherein the wire of the high-power light emitting unit and the ECU are electrically connected to a delay circuit, which is controlled by the ECU to delay or stop light emission of the high-power light emitting unit.

17. The automobile alerting device according to claim 13, wherein the wire of the high-power light emitting unit is electrically connected to an antitheft device of the automobile.

18. The automobile alerting device according to claim 14, wherein the wire of the high-power light emitting unit is electrically connected to an antitheft device of the automobile.
